(19) United States
(12) Patent Application Publication
(10) Pub. No.: US 2026/0154421 A1
(43) Pub. Date: Jun. 4, 2026

(54) ADVERSE EVENT RED-TEAMING CIRCUIT BREAKER FOR CLINICAL ARTIFICIAL INTELLIGENCE

(71) Applicant: George William Bickerstaff, III, Greenwich, CT (US)

(72) Inventor: George William Bickerstaff, III, Greenwich, CT (US)

(21) Appl. No.: 19/455,890

(22) Filed: Jan. 22, 2026

(51) Int. Cl. G06F 21/57; G06F 9/48; G06F 18/21

(52) U.S. Cl. CPC G06F 21/577; G06F 9/4812; G06F 18/217

(57) ABSTRACT

A hardware-based red-teaming circuit breaker continuously evaluates artificial intelligence inference outputs against adversarial validation criteria during runtime. The system interrupts execution upon detection of unsafe behavior and records escalation events in immutable logs. The invention provides a real-time safety net for autonomous artificial intelligence operating in regulated environments.

### TECHNICAL FIELD

The present invention relates to safety governance systems for artificial intelligence operating in regulated environments.

More specifically, the invention relates to hardware-enforced systems that continuously evaluate artificial intelligence behavior against adversarial and safety validation criteria during runtime.

The invention provides a deterministic circuit breaker that interrupts execution when an artificial intelligence system operates outside validated performance boundaries.

### BACKGROUND

Artificial intelligence systems deployed in clinical and diagnostic environments increasingly operate with limited human supervision.

As autonomy increases, so does the risk that an artificial intelligence model may encounter edge cases, adversarial inputs, or compounding logic failures.

Traditional validation approaches rely on pre-deployment testing and post-market monitoring rather than real-time enforcement.

Monitoring systems may detect adverse events only after harm has occurred.

Software-based safeguards are vulnerable to bypass, latency, or failure when inference systems degrade unexpectedly.

There exists a need for a deterministic, real-time mechanism that actively challenges an artificial intelligence system during execution.

Such a mechanism must interrupt execution before unsafe outputs propagate to downstream clinical workflows.

The present invention addresses these deficiencies by providing a hardware-based red-teaming circuit breaker that continuously evaluates inference outputs.

### SUMMARY OF THE INVENTION

The disclosed invention provides an adverse event red-teaming circuit breaker for artificial intelligence systems.

The circuit breaker continuously subjects inference outputs to adversarial and safety validation criteria during runtime.

When a violation condition is detected, execution is deterministically interrupted at an execution boundary.

The system operates within a trusted execution environment and is isolated from inference software.

All circuit breaker events are recorded in immutable escalation records suitable for regulatory review.

### DEFINITIONS

Adversarial Validation Criteria means predefined rules designed to stress or challenge artificial intelligence behavior.

Circuit Breaker means a hardware-enforced mechanism that interrupts execution upon detection of unsafe conditions.

Execution Boundary means a control point where inference outputs would affect downstream systems.

Red-Teaming means continuous adversarial evaluation of artificial intelligence behavior.

Self-Recognition Module means a component that assesses model confidence relative to validated bounds.

Trusted Execution Environment means a hardware-protected isolated execution space.

Validation Baseline Profile means an approved reference defining safe operating limits.

Violation Signal means a deterministic signal generated when unsafe behavior is detected.

### BRIEF DESCRIPTION OF THE DRAWINGS

FIG. 1 illustrates circuit breaker architecture.

FIG. 2 illustrates adversarial evaluation.

FIG. 3 illustrates self-recognition assessment.

FIG. 4 illustrates execution interruption.

FIG. 5 illustrates escalation logging.

### DETAILED DESCRIPTION OF THE DRAWINGS

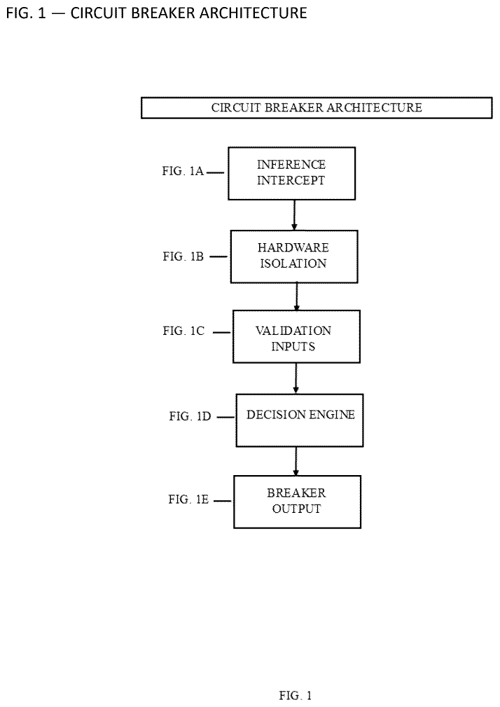

### FIG. 1—Circuit Breaker Architecture

FIG. 1A—INFERENCE INTERCEPT illustrates interception of inference outputs prior to reaching an execution boundary. Outputs are mirrored to the circuit breaker. This enables parallel evaluation.

FIG. 1B—HARDWARE ISOLATION illustrates isolation of the circuit

breaker within a trusted execution environment. Inference software cannot modify circuit logic. Tampering is prevented.

FIG. 1C—VALIDATION INPUTS illustrates ingestion of validation baseline profiles and adversarial criteria. Inputs are cryptographically protected. Unauthorized changes are blocked.

FIG. 1D—DECISION ENGINE illustrates a decision engine

evaluating inference outputs. Evaluation occurs deterministically. Latency is minimized.

FIG. 1E—BREAKER OUTPUT illustrates generation of an execution control signal. The signal determines whether execution proceeds or halts. Control is immediate.

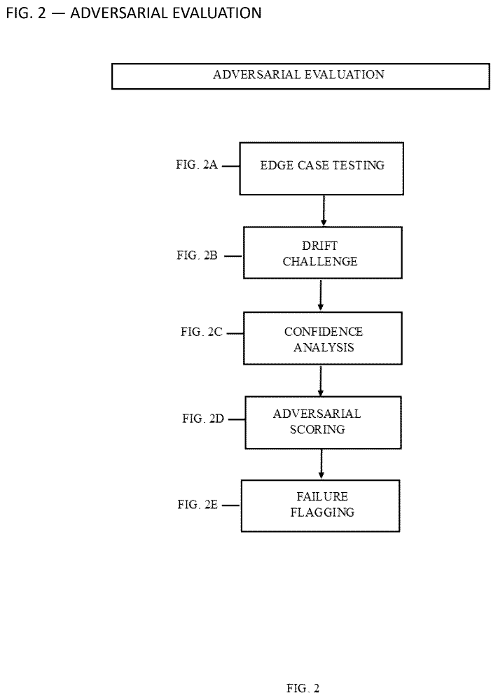

### FIG. 2—Adversarial Evaluation

FIG. 2A—EDGE CASE TESTING illustrates testing of inference outputs against known edge cases. Edge cases are defined by regulators or developers. Stress testing occurs in real time.

FIG. 2B—DRIFT CHALLENGE illustrates adversarial testing based on detected data drift. Drift thresholds are predefined. Exceedance triggers evaluation.

FIG. 2C—CONFIDENCE ANALYSIS illustrates analysis of model confidence values. Confidence is compared to validated ranges. Low confidence triggers caution.

FIG. 2D—ADVERSARIAL SCORING illustrates scoring of inference robustness. Scores reflect risk exposure. Unsafe scores trigger violation signals.

FIG. 2E—FAILURE FLAGGING illustrates flagging of inference failures. Flags propagate to the decision engine. Execution control is informed.

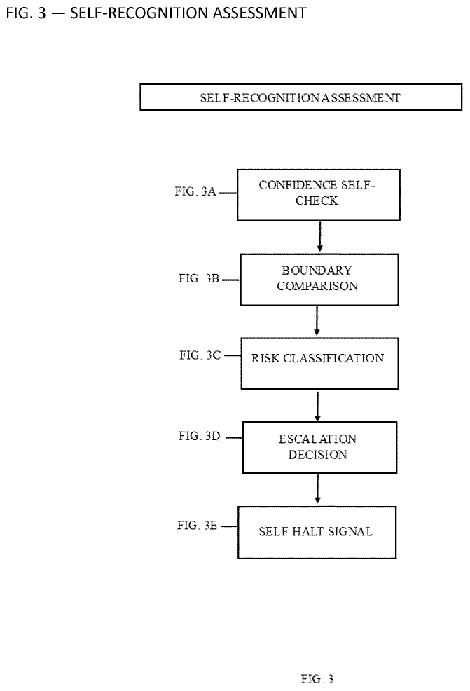

### FIG. 3—SELF-RECOGNITION ASSESSMENT

FIG. 3A—CONFIDENCE SELF-CHECK illustrates self-recognition of model confidence. The model assesses its own certainty. Assessment is continuous.

FIG. 3B—BOUNDARY COMPARISON illustrates comparison of confidence values to validation baselines. Boundaries are regulator-approved. Exceedance indicates risk.

FIG. 3C—RISK CLASSIFICATION illustrates classification of inference risk levels. Risk may be low, moderate, or high. Classification informs response.

FIG. 3D—ESCALATION DECISION illustrates determination of escalation necessity. High risk triggers escalation. Moderate risk may be logged.

FIG. 3E—SELF-HALT SIGNAL illustrates generation of a self-halt signal by the circuit breaker. The signal is deterministic. Execution is paused.

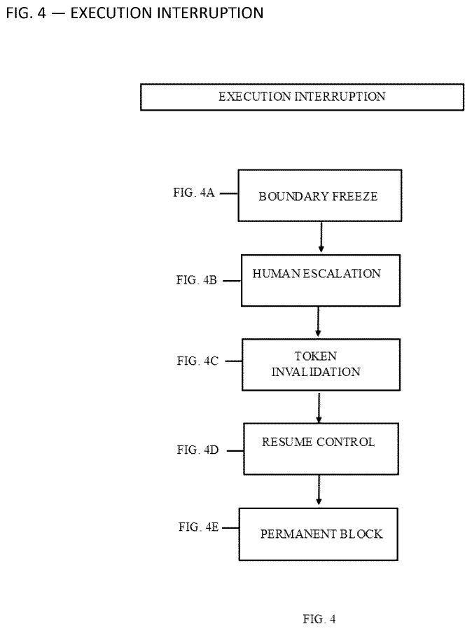

### FIG. 4—EXECUTION INTERRUPTION

FIG. 4A—BOUNDARY FREEZE illustrates freezing of outputs at the execution boundary. No downstream propagation occurs. Clinical actions are halted.

FIG. 4B—HUMAN ESCALATION illustrates routing of flagged events to human oversight systems. Human-in-the-loop review is enabled. Automation pauses.

FIG. 4C—TOKEN INVALIDATION illustrates invalidation of execution clearance tokens. Invalid tokens prevent further execution. Safety is enforced.

FIG. 4D—RESUME CONTROL illustrates controlled resumption following human approval. Approval criteria are predefined. Execution resumes safely.

FIG. 4E—PERMANENT BLOCK illustrates permanent blocking after repeated violations. Blocking protects system integrity. Regulatory compliance is preserved.

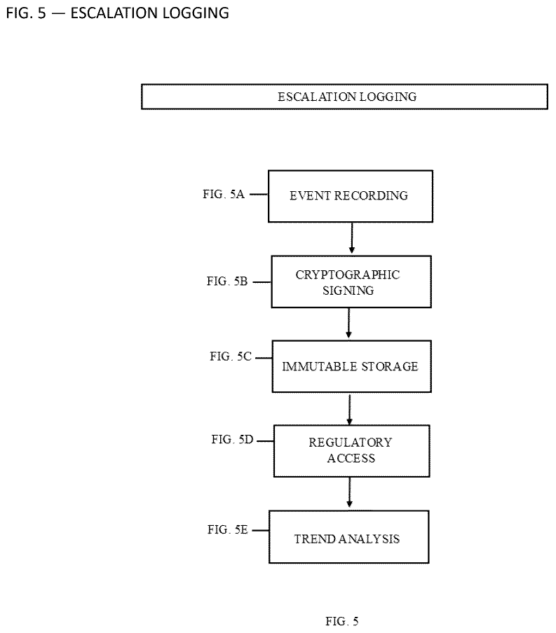

### FIG. 5—ESCALATION LOGGING

FIG. 5A—EVENT RECORDING illustrates recording of all circuit breaker events. Records include timestamps and inference context. Completeness is ensured.

FIG. 5B—CRYPTOGRAPHIC SIGNING illustrates signing of escalation records. Signing prevents repudiation. Integrity is enforced.

FIG. 5C—IMMUTABLE STORAGE illustrates storage of records in a tamper-resistant log. Logs are append-only. Alteration is prevented.

FIG. 5D—REGULATORY ACCESS illustrates retrieval of records for regulatory inspection. Access is read-only. Transparency is preserved.

FIG. 5E—TREND ANALYSIS illustrates analysis of repeated adverse events. Trends inform retraining or suspension decisions. Governance improves over time.

### EXAMPLES

In one example, a diagnostic AI encounters an unseen data distribution causing confidence collapse. The circuit breaker detects the violation and freezes execution. Human review is initiated.

In another example, repeated low-risk violations accumulate. The circuit breaker escalates and permanently blocks execution. Audit records support regulatory review.

1. A system for interrupting artificial intelligence execution in a regulated environment, comprising:
a hardware-based circuit breaker operating within a trusted execution environment;
logic configured to subject inference outputs to adversarial validation criteria during runtime; and
control circuitry configured to interrupt execution at an execution boundary upon detection of a violation signal.

2. A computer-implemented method comprising:
evaluating inference outputs against adversarial and safety validation criteria during runtime;
detecting a violation condition based on comparison to a validation baseline profile; and
interrupting execution of the artificial intelligence system prior to downstream propagation.

3. A self-recognition control module configured to prevent execution of an artificial intelligence system when model confidence falls outside validated bounds.

4. The system of claim 1, wherein interruption includes freezing a clinical report.

5. The method of claim 2, wherein detection of a violation triggers human-in-the-loop escalation.

6. The self-recognition control module of claim 3, wherein execution requires a verified clearance token.

7. The system of claim 1, wherein violation detection occurs within the trusted execution environment.

8. The method of claim 2, wherein adversarial evaluation includes testing against drift thresholds.

9. The self-recognition control module of claim 3, wherein action intent is captured to assess risk severity.

10. The system of claim 1, wherein all execution interruptions are recorded in immutable escalation records.
